(19) United States
(12) Patent Application Publication
(10) Pub. No.: US 2026/0219687 A1
(43) Pub. Date: Jul. 30, 2026

(54) UNMANNED AERIAL VEHICLE CONTROL

(71) Applicant: Beijing Sankuai Online Technology Co., Ltd., Beijing (CN)

(72) Inventors: Jingyang WANG, Beijing (CN); Pei WANG, Beijing (CN); Gen LI, Beijing (CN); Yiming ZHANG, Beijing (CN)

(21) Appl. No.: 19/146,968

(22) PCT Filed: Dec. 12, 2023
(86) PCT No.: PCT/CN2023/138188

§ 371 Date: Jul. 10, 2025

(30) Foreign Application Priority Data
Feb. 7, 2023 (CN) 202310141493.X

(51) Int. Cl. G05D 1/654; G05D 1/242; G05D 111/30

(52) U.S. Cl. CPC G05D 1/654; G05D 1/242; G05D 2111/30

(57) ABSTRACT

A method for controlling an unmanned aerial vehicle includes: receiving, by a signal receiving apparatus, an electromagnetic wave signal periodically transmitted by a signal transmitting apparatus; determining a Doppler frequency value of a current location of the unmanned aerial vehicle according to the electromagnetic wave signal; controlling the unmanned aerial vehicle to fly in a target flight path to a target location according to the Doppler frequency value of the current location; determining a target landing location corresponding to the unmanned aerial vehicle according to a plurality of Doppler frequency values determined in the target flight path of the unmanned aerial vehicle, wherein a location of the signal transmitting apparatus or the signal receiving apparatus is below the target landing location; and controlling the unmanned aerial vehicle to land at the target landing location.

The present application is a U.S. National Stage Application of International Application No. PCT/CN2023/138188, filed on Dec. 12, 2023, which is based upon and claims priority to Chinese Patent Application No. 202310141493.X, entitled “METHOD AND APPARATUS FOR CONTROLLING UNMANNED AERIAL VEHICLE, STORAGE MEDIUM AND ELECTRONIC DEVICE” and filed with the China National Intellectual Property Administration on Feb. 7, 2023. The foregoing applications are incorporated herein by reference in their entities.

### TECHNICAL FIELD

The present disclosure relates to the technical field of unmanned aerial vehicles, and in particular, to control of an unmanned aerial vehicle.

### BACKGROUND

With wide application of unmanned aerial vehicles, the unmanned aerial vehicles have increasingly wider application scenarios. In a delivery scenario using an unmanned aerial vehicle, the unmanned aerial vehicle needs to accurately land to a specified location. Currently, an unmanned aerial vehicle lands based on Global Navigation Satellite System (GNSS) positioning assistance, to land at a specified location.

### SUMMARY

The present disclosure provides control of an unmanned aerial vehicle. A process of controlling the unmanned aerial vehicle includes but is not limited to the following aspects.

According to a first aspect, the present disclosure provides a method for controlling an unmanned aerial vehicle, which includes: receiving, by a signal receiving apparatus, an electromagnetic wave signal periodically transmitted by a signal transmitting apparatus; determining a Doppler frequency value of a current location of the unmanned aerial vehicle according to the electromagnetic wave signal; controlling the unmanned aerial vehicle to fly in a target flight path to a target location according to the Doppler frequency value of the current location, where the target flight path includes flight paths respectively corresponding to a current flight direction and a target flight direction of the unmanned aerial vehicle, and the target flight direction forms an orthogonality relationship with the current flight direction; determining a target landing location corresponding to the unmanned aerial vehicle according to a plurality of Doppler frequency values determined in the target flight path of the unmanned aerial vehicle, where a location of the signal transmitting apparatus or the signal receiving apparatus is below the target landing location; and controlling the unmanned aerial vehicle to land at the target landing location.

In some embodiments, the controlling the unmanned aerial vehicle to fly in a target flight path to a target location according to the Doppler frequency value of the current location includes: determining a first location and a second location according to the Doppler frequency value of the current location; controlling the unmanned aerial vehicle to fly in the current flight direction from the first location to the second location; determining the target flight direction according to the current flight direction; and controlling the unmanned aerial vehicle to fly in the target flight direction from the second location to the target location.

In some embodiments, the determining a first location and a second location according to the Doppler frequency value of the current location includes: determining the first location, where a difference between the Doppler frequency value of the current location and a frequency threshold is less than or equal to a difference threshold when the current location is the first location; and determining the second location according to the first location, the current flight direction, and a first flight distance.

In some embodiments, the determining the target flight direction according to the current flight direction includes: determining a first flight direction according to the current flight direction, where the first flight direction is any direction that forms an orthogonality relationship with the current flight direction; controlling the unmanned aerial vehicle to fly in the first flight direction from the second location for a reference duration; and determining the target flight direction according to a plurality of first Doppler frequency values and the first flight direction, where the plurality of first Doppler frequency values are determined in a flight process of the reference duration.

In some embodiments, the determining the target flight direction according to a plurality of first Doppler frequency values and the first flight direction includes: using the first flight direction as the target flight direction when determining that the plurality of first Doppler frequency values are all greater than or equal to the frequency threshold; or, using a second flight direction as the target flight direction when determining that the plurality of first Doppler frequency values are all less than the frequency threshold, where the second flight direction is opposite to the first flight direction.

In some embodiments, the controlling the unmanned aerial vehicle to fly in the target flight direction from the second location to the target location includes: determining a third location in the target flight direction, where a difference between a Doppler frequency value of the third location and the frequency threshold is less than or equal to the difference threshold; determining the target location according to the third location and the target flight direction; and controlling the unmanned aerial vehicle to fly in the target flight direction from the third location to the target location.

In some embodiments, before the receiving, by a signal receiving apparatus, an electromagnetic wave signal periodically transmitted by a signal transmitting apparatus, the method for controlling an unmanned aerial vehicle further includes: determining that the unmanned aerial vehicle flies to a landing region in a fixed-height mode at a constant speed, where the landing region includes the target flight path.

In some embodiments, the signal receiving apparatus is located at the unmanned aerial vehicle, and the signal transmitting apparatus is located below the target landing location; or, the signal transmitting apparatus is located at the unmanned aerial vehicle, and the signal receiving apparatus is located below the target landing location.

In some embodiments, the determining a target landing location corresponding to the unmanned aerial vehicle according to a plurality of Doppler frequency values determined in the target flight path of the unmanned aerial vehicle includes: determining the target landing location by means of two-dimensional curve fitting based on the plurality of Doppler frequency values and locations corresponding to the plurality of Doppler frequency values.

According to a second aspect, the present disclosure provides an apparatus for controlling an unmanned aerial vehicle, which includes:
a receiving module, configured to receive, by a signal receiving apparatus, an electromagnetic wave signal periodically transmitted by a signal transmitting apparatus;
a first determining module, configured to determine a Doppler frequency value of a current location of the unmanned aerial vehicle according to the electromagnetic wave signal;
a first control module, configured to control the unmanned aerial vehicle to fly in a target flight path to a target location according to the Doppler frequency value of the current location, where the target flight path includes flight paths respectively corresponding to a current flight direction and a target flight direction of the unmanned aerial vehicle, and the target flight direction forms an orthogonality relationship with the current flight direction;
a second determining module, configured to determine a target landing location corresponding to the unmanned aerial vehicle according to a plurality of Doppler frequency values determined in the target flight path of the unmanned aerial vehicle, where a location of the signal transmitting apparatus or the signal receiving apparatus is below the target landing location; and
a second control module, configured to control the unmanned aerial vehicle to land at the target landing location.

In some embodiments, the first control module is configured to: determine a first location and a second location according to the Doppler frequency value of the current location; control the unmanned aerial vehicle to fly in the current flight direction from the first location to the second location; determine the target flight direction according to the current flight direction; and control the unmanned aerial vehicle to fly in the target flight direction from the second location to the target location.

In some embodiments, the first control module is configured to: determine the first location, where a difference between the Doppler frequency value of the current location and a frequency threshold is less than or equal to a difference threshold when the current location is the first location; and determine the second location according to the first location, the current flight direction, and a first flight distance.

In some embodiments, the first control module is configured to: determine a first flight direction according to the current flight direction, where the first flight direction is any direction that forms an orthogonality relationship with the current flight direction; control the unmanned aerial vehicle to fly in the first flight direction from the second location for a reference duration; and determine the target flight direction according to a plurality of first Doppler frequency values and the first flight direction, where the plurality of first Doppler frequency values are determined in a flight process of the reference duration.

In some embodiments, the first control module is configured to: use the first flight direction as the target flight direction when determining that the plurality of first Doppler frequency values are all greater than or equal to the frequency threshold; or, use a second flight direction as the target flight direction when determining that the plurality of first Doppler frequency values are all less than the frequency threshold, where the second flight direction is opposite to the first flight direction.

In some embodiments, the first control module is configured to: determine a third location in the target flight direction, where a difference between a Doppler frequency value of the third location and the frequency threshold is less than or equal to the difference threshold; determine the target location according to the third location and the target flight direction; and control the unmanned aerial vehicle to fly in the target flight direction from the third location to the target location.

In some embodiments, the apparatus further includes a third determining module, configured to determine that the unmanned aerial vehicle flies to a landing region in a fixed-height mode at a constant speed, where the landing region includes the target flight path.

In some embodiments, the signal receiving apparatus is located at the unmanned aerial vehicle, and the signal transmitting apparatus is located below the target landing location; or, the signal transmitting apparatus is located at the unmanned aerial vehicle, and the signal receiving apparatus is located below the target landing location.

In some embodiments, the second determining module is configured to determine the target landing location by means of two-dimensional curve fitting based on the plurality of Doppler frequency values and locations corresponding to the plurality of Doppler frequency values.

According to a third aspect, the present disclosure provides a non-transitory computer-readable storage medium, having a computer program stored thereon. When executed by a processor, the computer program implements steps of the method according to the first aspect, or any optional embodiment of the first aspect of the present disclosure.

According to a fourth aspect, the present disclosure provides an electronic device, which includes: a memory, having a computer program stored thereon; and a processor, configured to execute the computer program in the memory, to implement steps of the method according to the first aspect, or any optional embodiment of the first aspect of the present disclosure.

According to a fifth aspect, the present disclosure provides a computer program product. The computer program product includes a computer program. The computer program is executable by a programmable apparatus, and when the computer program is executed by the programmable apparatus, the computer program performs steps of the method according to the first aspect, or any optional embodiment of the first aspect of the present disclosure.

According to the aforementioned technical solutions, the electromagnetic wave signal periodically transmitted by the signal transmitting apparatus is received by the signal receiving apparatus; the Doppler frequency value of the current location of the unmanned aerial vehicle is determined according to the electromagnetic wave signal; the unmanned aerial vehicle is controlled to fly in the target flight path to the target location according to the Doppler frequency value of the current location, where the target flight path includes the flight path corresponding to the current flight direction of the unmanned aerial vehicle and the flight path corresponding to the target flight direction that forms an orthogonality relationship with the current flight direction; the target landing location corresponding to the unmanned aerial vehicle is determined according to the plurality of Doppler frequency values determined in the target flight path of the unmanned aerial vehicle, where the location of the signal transmitting apparatus or the signal receiving apparatus is below the target landing location; and the unmanned aerial vehicle is controlled to land at the target landing location. In other words, in the present disclosure, the Doppler frequency values of a plurality of locations in the flight process of the unmanned aerial vehicle may be determined according to the electromagnetic wave signal transmitted between the unmanned aerial vehicle and a landing point, the target landing location may be determined according to the plurality of Doppler frequency values, and the unmanned aerial vehicle is controlled to land at the target landing location, thereby achieving precise landing of the unmanned aerial vehicle.

Other features and advantages of the present disclosure will be described in detail in the following detailed description of the embodiments.

### BRIEF DESCRIPTION OF THE DRAWINGS

FIG. 1 is a flowchart of a method for controlling an unmanned aerial vehicle according to an exemplary embodiment of the present disclosure;

FIG. 2 is a schematic diagram of a landing system for an unmanned aerial vehicle according to an exemplary embodiment of the present disclosure;

FIG. 3 is a slope distance thermodynamic diagram according to an exemplary embodiment of the present disclosure;

FIG. 4 is a Doppler phase thermodynamic diagram according to an exemplary embodiment of the present disclosure;

FIG. 5 is a flowchart of another method for controlling an unmanned aerial vehicle according to an exemplary embodiment of the present disclosure;

FIG. 6 is a flowchart of another method for controlling an unmanned aerial vehicle according to an exemplary embodiment of the present disclosure;

FIG. 7 is a flowchart of another method for controlling an unmanned aerial vehicle according to an exemplary embodiment of the present disclosure;

FIG. 8 is a schematic diagram of a process of guiding an unmanned aerial vehicle to land according to an exemplary embodiment of the present disclosure;

FIG. 9 is a block diagram of an apparatus for controlling an unmanned aerial vehicle according to an exemplary embodiment of the present disclosure;

FIG. 10 is a block diagram of another apparatus for controlling an unmanned aerial vehicle according to an exemplary embodiment of the present disclosure;

FIG. 11 is a block diagram of an electronic device according to an exemplary embodiment of the present disclosure; and

FIG. 12 is a block diagram of another electronic device according to an exemplary embodiment of the present disclosure.

### DETAILED DESCRIPTION OF THE EMBODIMENTS

Specific implementations of the present disclosure are described in detail below with reference to the accompanying drawings. It should be understood that the specific implementations described herein are merely used for describing and explaining the present disclosure, but are not intended to limit the present disclosure.

It should be noted that, in the present disclosure, all actions of obtaining signals, information, or data are performed while complying with corresponding data protection regulation policies of a country where the actions are performed, with authorization granted by an owner of a corresponding apparatus.

In the following description, the terms such as “first” and “second” are only used for distinguishing the description and cannot be understood as indicating or implying relative importance, nor can they be understood as indicating or implying order.

First, an application scenario of the present disclosure is described. Currently, positioning of an unmanned aerial vehicle in a landing process may be performed by means of GNSS or a visual system. The GNSS has relatively low positioning precision, and although visual positioning has relatively high positioning precision, the visual positioning is easily affected by bad weather. In a related technology, precise positioning of an unmanned aerial vehicle is assisted by a sensor. For example, a three-coordinate radar-based guidance and positioning system can accurately measure a three-dimensional location of an unmanned aerial vehicle. However, a three-dimensional radar is relatively high in price, resulting in relatively high overall costs of an unmanned aerial vehicle, which is not applicable to scenarios such as delivery. In addition, the three-dimensional radar needs to be subject to complex error calibration and pose estimation after being used for a period of time, affecting the operation efficiency of the unmanned aerial vehicle.

The present disclosure provides a method and apparatus for controlling an unmanned aerial vehicle, a storage medium, and an electronic device, to solve problems in the related technology. Doppler frequency values of a plurality of locations in a flight process of the unmanned aerial vehicle may be determined according to an electromagnetic wave signal transmitted between the unmanned aerial vehicle and a landing point; a target landing location may be determined according to the plurality of Doppler frequency values; and the unmanned aerial vehicle is controlled to land at the target landing location, thereby achieving precise landing of the unmanned aerial vehicle.

The present disclosure is described below with reference to specific embodiments.

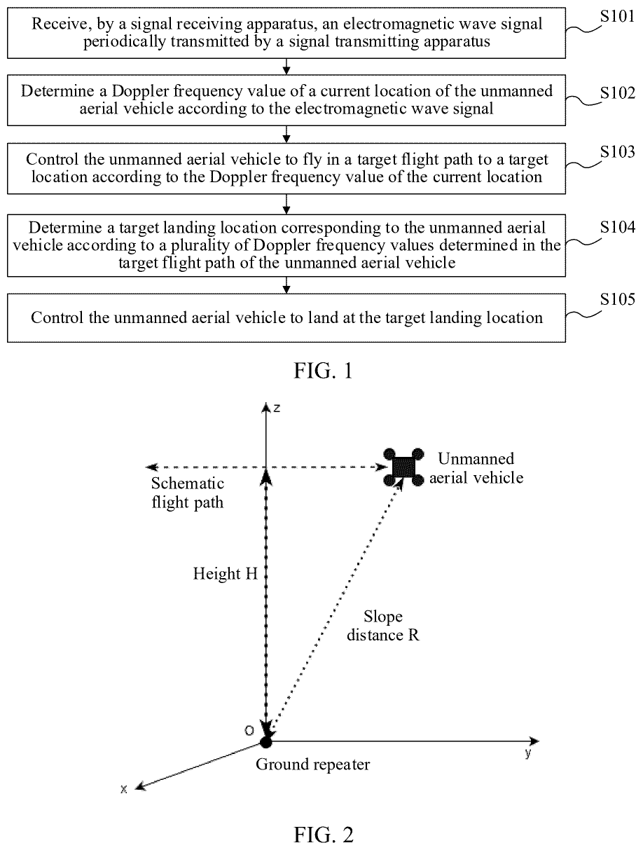

FIG. 1 is a flowchart of a method for controlling an unmanned aerial vehicle according to an exemplary embodiment of the present disclosure. As shown in FIG. 1, the method may include:

S101: Receive, by a signal receiving apparatus, an electromagnetic wave signal periodically transmitted by a signal transmitting apparatus.

The electromagnetic wave signal may be a single-frequency sine wave, a stepped-frequency continuous wave, or a frequency-modulated continuous wave. The specific type of the electromagnetic wave signal is not limited in the present disclosure. The signal receiving apparatus may be located at the unmanned aerial vehicle, and correspondingly, the signal transmitting apparatus is located below a target landing location. The target landing location may be any location in the air, and the unmanned aerial vehicle can fly to the target landing location. Exemplarily, the signal transmitting apparatus may be placed at the center of a parking apron at a ground end, to radiate the electromagnetic wave signal to the air, and the signal receiving apparatus may be located at the center of the unmanned aerial vehicle. Alternatively, the locations of the signal transmitting apparatus and the signal receiving apparatus may be exchanged, i.e., the signal transmitting apparatus may be located at the unmanned aerial vehicle, and correspondingly, the signal receiving apparatus is located below the target landing location. Exemplarily, the signal transmitting apparatus is located at the center of the unmanned aerial vehicle, and the signal receiving apparatus is placed at the center of the parking apron at the ground end.

If the signal receiving apparatus is located at the center of the unmanned aerial vehicle, the unmanned aerial vehicle is directly controlled according to related control information after the signal receiving apparatus determines the control information (for example, according to the received electromagnetic wave signal). Exemplarily, the control information is used for controlling the unmanned aerial vehicle to land at the target landing location. Alternatively, if the signal receiving apparatus is placed at the center of the parking apron on the ground, after the signal receiving apparatus determines related control information, the control information needs to be sent to the unmanned aerial vehicle to control the unmanned aerial vehicle. The present disclosure is described by using an example where the signal transmitting apparatus is placed at the center of the parking apron at the ground end, and the signal receiving apparatus is located at the center of the unmanned aerial vehicle.

It should be noted that the signal transmitting apparatus may be a single radiation source or a signal repeater. In a case that the signal transmitting apparatus is a single radiation source, the signal receiving apparatus may be a radio frequency receiver, the single radiation source may transmit an electromagnetic wave signal, and the radio frequency receiver may receive the electromagnetic wave signal transmitted by the single radiation source. Alternatively, in a case that the signal transmitting apparatus is a signal repeater, the signal receiving apparatus may be a radar module. Because the radar module uses an echo, the radar module may transmit an electromagnetic wave signal. After receiving the electromagnetic wave signal, the signal repeater may repeat the electromagnetic wave signal, and the radar module may receive the electromagnetic wave signal repeated by the signal repeater.

In this step, the signal transmitting apparatus may continuously transmit the electromagnetic wave signal. When determining to land, the unmanned aerial vehicle may fly straight in a direction close to the signal transmitting apparatus, in a fixed-height mode at a constant speed close to the ground, and receive, by the signal receiving apparatus, the electromagnetic wave signal transmitted by the signal transmitting apparatus. The fixed-height mode, constant speed, and straight flight are merely examples herein. According to different actual requirements, the unmanned aerial vehicle may also use other flight modes, a variable speed, or a non-straight flight manner.

S102: Determine a Doppler frequency value of a current location of the unmanned aerial vehicle according to the electromagnetic wave signal.

It should be noted that the current location is a location at which the unmanned aerial vehicle receives the electromagnetic wave signal. In a flight process of the unmanned aerial vehicle, the current location also changes all the time. Exemplarily, if the unmanned aerial vehicle receives the electromagnetic wave signal when flying to a location X, the location X is the current location. If the unmanned aerial vehicle receives the electromagnetic wave signal again when flying from the location X to a location Y, the location Y is the current location.

In this step, after each time the signal receiving apparatus of the unmanned aerial vehicle receives the electromagnetic wave signal, modulation and demodulation processing may be performed on the electromagnetic wave signal to obtain a Doppler phase value of the current location of the unmanned aerial vehicle, and then a Doppler frequency value of the current location of the unmanned aerial vehicle may be determined according to the Doppler phase value by short-time Fourier transform (STFT).

S103: Control the unmanned aerial vehicle to fly in a target flight path to a target location according to the Doppler frequency value of the current location.

The target flight path includes a flight path corresponding to a current flight direction of the unmanned aerial vehicle and a flight path corresponding to a target flight direction that forms an orthogonality relationship with the current flight direction. In other words, the target flight path includes flight paths respectively corresponding to the current flight direction and the target flight direction of the unmanned aerial vehicle, and the target flight direction forms an orthogonality relationship with the current flight direction.

In this step, the unmanned aerial vehicle may fly straight in the current flight direction at a constant speed. When it is determined that a difference between the Doppler frequency value and a preset frequency threshold is less than or equal to a preset difference threshold, the unmanned aerial vehicle is controlled to continue to fly for a first preset flight distance. A path formed by the unmanned aerial vehicle continuing to fly for the first preset flight distance is the flight path corresponding to the current flight direction of the unmanned aerial vehicle. The target flight direction is determined according to the current flight direction, and the unmanned aerial vehicle continues to fly in the target flight direction. When it is determined that the difference between the Doppler frequency value and the preset frequency threshold is less than or equal to the preset difference threshold, the unmanned aerial vehicle continues to fly for a second preset flight distance to arrive at the target location. A path formed by the unmanned aerial vehicle continuing to fly for the second preset flight distance is the flight path corresponding to the target flight direction of the unmanned aerial vehicle.

The preset frequency threshold may be 0, or may be a value close to 0. The preset difference threshold may be 0. The first preset flight distance and the second preset flight distance may be preset according to a flight height of the unmanned aerial vehicle. The first preset flight distance and the second preset flight distance may be the same or different, which is not limited in the present disclosure. In addition, presetting is merely an exemplary manner for obtaining the frequency threshold, and the frequency threshold may also be obtained in other manners. Therefore, the preset frequency threshold may also be referred to as a frequency threshold. Correspondingly, the preset difference threshold may also be referred to as a difference threshold, the first preset flight distance may also be referred to as a first flight distance, and the second preset flight distance may also be referred to as a second flight distance.

S104: Determine a target landing location corresponding to the unmanned aerial vehicle according to a plurality of Doppler frequency values determined in the target flight path of the unmanned aerial vehicle.

The location of the signal transmitting apparatus or the signal receiving apparatus is below the target landing location.

In a possible implementation, after the unmanned aerial vehicle arrives at the target location, each of the Doppler frequency values stored in the unmanned aerial vehicle may be obtained, and the target landing location may be determined by means of two-dimensional curve fitting based on the plurality of Doppler frequency values and locations corresponding to the plurality of Doppler frequency values. Exemplarily, the plurality Doppler frequency values may be fitted by a two-dimensional curve fitting method. Exemplarily, a target landing location of which the Doppler frequency value is 0, or a target landing location of which the Doppler frequency value is less than a reference threshold is determined. The reference threshold is not limited in the present disclosure.

In addition, a relative location relationship between the current target location of the unmanned aerial vehicle and the target landing location, and a target height between the unmanned aerial vehicle and the signal transmitting apparatus may further be determined by means of two-dimensional curve fitting.

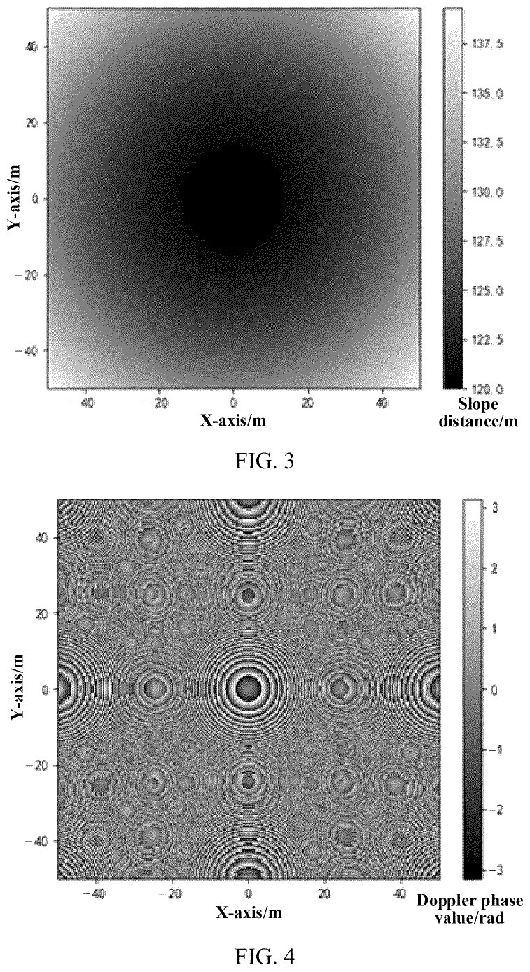

Exemplarily, FIG. 2 is a schematic diagram of a landing system for an unmanned aerial vehicle according to an exemplary embodiment of the present disclosure. As shown in FIG. 2, the landing system for an unmanned aerial vehicle includes a signal transmitting apparatus and an unmanned aerial vehicle. An x-axis positive direction is horizontally eastward, a y-axis positive direction is horizontally northward, and a z-axis positive direction is vertically upward. When the unmanned aerial vehicle flies according to a height H (i.e., the aforementioned target height), a slope distance between the unmanned aerial vehicle and the signal transmitting apparatus (which is shown as a repeater on the ground in FIG. 2) is R. A relative location between the unmanned aerial vehicle and the signal transmitting apparatus may be calculated by the following formula (1):

$$R ( t ) = \sqrt{{H}^{2} + {x}_{U}^{2} ( t ) + {y}_{U}^{2} ( t )} = \sqrt{{H}^{2} + {ρ}_{U}^{2} ( t )} \qquad ( 1 )$$

where R(t) represents the relative location between the unmanned aerial vehicle and the signal transmitting apparatus at a moment t; (x_{U}(t),y_{U}(t),H) represents the location of the unmanned aerial vehicle at the moment t; and

$${ρ}_{U} ( t ) = \sqrt{{x}_{U}^{2} ( t ) + {y}_{U}^{2} ( t )}$$

represents a polar axis length (which may reflect the relative location relationship between the target location and the target landing location as described above) of the unmanned aerial vehicle on a z=H equal-height plane at the moment t. If the signal transmitting apparatus transmits a single-frequency sine electromagnetic wave, with a signal frequency of f_{c} and a light speed of c, then the wave length of the electromagnetic wave is λ_{c}=c/f_{c}. According to a radar detection principle, the following formula (2) may be obtained for the Doppler phase values of the unmanned aerial vehicle observed at different moments:

$${ϕ}_{dopp} ( t ) = - \frac{4 π R ( t )}{{λ}_{c}} = - \frac{4 π}{{λ}_{c}} \sqrt{{H}^{2} + {ρ}_{U}^{2} ( t )} \qquad ( 2 )$$

where φ_{dopp}(t) is the Doppler phase value of the unmanned aerial vehicle at the moment t.

A Doppler frequency value may be derived from a Doppler phase value. It may be learned from the formula (2) that, when the unmanned aerial vehicle is close to (0, 0, H), the Doppler frequency value is positive; when the unmanned aerial vehicle is far from (0, 0, H), the Doppler frequency value is negative; and when the unmanned aerial vehicle is at (0, 0, H), namely located right above the signal transmitting apparatus, the Doppler frequency value is 0 no matter in which direction the unmanned aerial vehicle flies.

Based on the above description, with the height H being 120 meters as an example, FIG. 3 is a slope distance thermodynamic diagram according to an exemplary embodiment of the present disclosure, and FIG. 4 is a Doppler phase thermodynamic diagram according to an exemplary embodiment of the present disclosure. As shown in FIG. 3 and FIG. 4, the Doppler frequency value of a location (0, 0, H) right above the signal transmitting apparatus is 0.

It can be learned from the formula (1) and formula (2) that, the Doppler phase value φ_{dopp}(t) is in direct proportion to the slope distance R, and the direct proportion may be represented by a hyperbolic curve. In the present disclosure, a hyperbolic model may be fitted based on a plurality of Doppler frequency values, to determine the target landing location and the target height.

S105: Control the unmanned aerial vehicle to land at the target landing location.

In this step, after the target landing location is determined, according to a relative location relationship between the current target location and the target landing location of the unmanned aerial vehicle, the unmanned aerial vehicle may be controlled to fly from the target location to the target landing location, and the unmanned aerial vehicle is controlled to land at the target landing location according to the target height.

In a possible implementation, after it is determined that the unmanned aerial vehicle flies to a preset landing region in a fixed-height mode at a constant speed, the electromagnetic wave signal periodically transmitted by the signal transmitting apparatus is received by the signal receiving apparatus. The preset landing region includes the target flight path. Exemplarily, the preset landing region may be a preset region centering on the parking apron on the ground, and the preset region may be a rectangle or a circle, which is not limited in the present disclosure. Certainly, presetting is merely an exemplary manner for obtaining the landing region, and the landing region may also be obtained in other manners. Therefore, the preset landing region may also be referred to as a landing region.

By using the above method, the Doppler frequency values of the plurality of locations in the flight process of the unmanned aerial vehicle may be determined according to the electromagnetic wave signal transmitted between the unmanned aerial vehicle and the landing point, the target landing location may be determined according to the plurality of Doppler frequency values, and the unmanned aerial vehicle is controlled to land at the target landing location, thereby achieving precise landing of the unmanned aerial vehicle. In addition, the unmanned aerial vehicle does not need a communication link to participate during the entire landing process, thereby saving costs of the unmanned aerial vehicle. Further, in a case that the signal transmitting apparatus is a signal repeater, the signal repeater can amplify the electromagnetic wave signal when repeating the electromagnetic wave signal, thereby increasing a control range of the unmanned aerial vehicle.

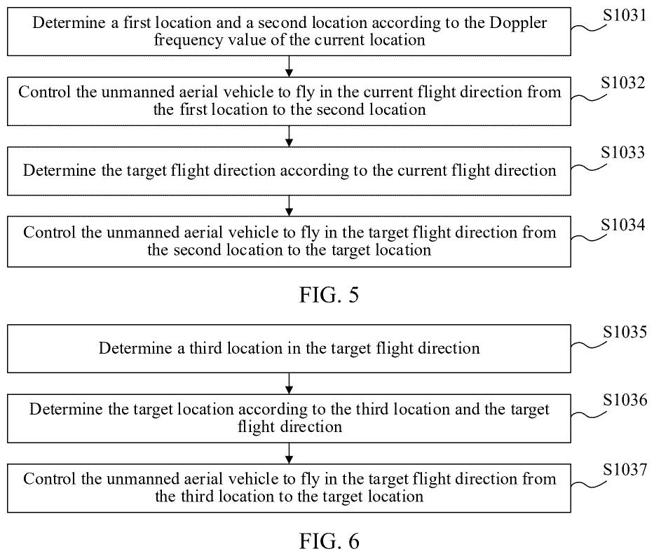

FIG. 5 is a flowchart of another method for controlling an unmanned aerial vehicle according to an exemplary embodiment of the present disclosure. As shown in FIG. 5, an implementation of S103 may include:

S1031: Determine a first location and a second location according to the Doppler frequency value of the current location.

S1032: Control the unmanned aerial vehicle to fly in the current flight direction from the first location to the second location.

S1033: Determine the target flight direction according to the current flight direction.

S1034: Control the unmanned aerial vehicle to fly in the target flight direction from the second location to the target location.

Exemplarily, in the flight process of the unmanned aerial vehicle, after each time the signal receiving apparatus determines the Doppler frequency value of the current location according to the electromagnetic wave signal, the signal receiving apparatus may compare the Doppler frequency value of the current location with the preset frequency threshold. If the difference between the Doppler frequency value of the current location and the preset frequency threshold is less than or equal to the preset difference threshold, the current location is used as the first location. In other words, in this embodiment of the present application, the first location may be determined, and the difference between the Doppler frequency value of the current location and the frequency threshold is less than or equal to the difference threshold when the current location is the first location. The second location is determined according to the first location, the current flight direction, and the first preset flight distance after the first location is determined.

For example, if the Doppler frequency value of the current location is 0, the current location is used as the first location. The first preset flight distance may be determined by a preset distance association relationship according to the current flight height of the unmanned aerial vehicle. The distance association relationship may include a correspondence between different heights and flight distances.

After the first location is determined, the unmanned aerial vehicle may be controlled to continue to fly in the current flight direction for the first preset flight distance, to arrive at the second location. Then, a first flight direction is determined according to the current flight direction, and the first flight direction is any direction that forms an orthogonality relationship with the current flight direction. The unmanned aerial vehicle is controlled to fly in the first flight direction from the second location for a preset duration. The target flight direction is determined according to a plurality of first Doppler frequency values and the first flight direction, and the plurality of first Doppler frequency values are determined in a flight process of the preset duration.

In this embodiment of the present application, the unmanned aerial vehicle may also be controlled to fly in the first flight direction from the second location for a reference duration. The reference duration obtained by presetting is the preset duration, and the reference duration may also be obtained in other manners besides presetting. Correspondingly, the plurality of first Doppler frequency values are determined in a flight process of the reference duration.

Exemplarily, in the flight process of the unmanned aerial vehicle within the preset duration, a Doppler frequency value determined each time may be stored. After the unmanned aerial vehicle flies for the preset duration, a plurality of stored first Doppler frequency values of the unmanned aerial vehicle flying within the preset duration may be obtained, and the target flight direction is determined according to the plurality of first Doppler frequency values and the first flight direction. The preset duration may be preset according to experience. Exemplarily, the preset duration may be 100 ms.

It should be noted that the preset duration may also be a preset distance. For example, the unmanned aerial vehicle is controlled to fly a preset distance in the first flight direction from the second location, which is not limited in the present disclosure.

In a possible implementation, the first flight direction is used as the target flight direction when it is determined that the plurality of first Doppler frequency values are all greater than or equal to the preset frequency threshold; or, a second flight direction is used as the target flight direction when it is determined that the plurality of first Doppler frequency values are all less than the preset frequency threshold, where the second flight direction is opposite to the first flight direction.

Exemplarily, after the unmanned aerial vehicle arrives at the second location, according to the current flight direction of the unmanned aerial vehicle, one direction may be selected from two directions that form an orthogonality relationship with the current flight direction, as the first flight direction. The preset duration is obtained, and the unmanned aerial vehicle is controlled to fly in the first flight direction for the preset duration. In the flight process of the unmanned aerial vehicle in the first flight direction, the signal receiving apparatus of the unmanned aerial vehicle determines the Doppler frequency value according to the received electromagnetic wave signal. After the unmanned aerial vehicle completes flight for the preset duration, a plurality of first Doppler frequency values during the flight for the preset duration may be obtained. With the preset frequency threshold being 0 as an example, if the plurality of first Doppler frequency values are all greater than or equal to 0, then it indicates that the first flight direction points to the signal transmitting apparatus, the first flight direction may be used as the target flight direction, and the unmanned aerial vehicle is controlled to continue to fly in the target flight direction until the unmanned aerial vehicle arrives at the target location. If it is determined that the plurality of first Doppler frequency values are all less than 0, then it indicates that the unmanned aerial vehicle flies in a direction away from the signal transmitting apparatus. In this case, the second flight direction may be determined according to the first flight direction, the second flight direction is used as the target flight direction, and the unmanned aerial vehicle is controlled to start to fly in the target flight direction from the current location until the unmanned aerial vehicle flies to the target location.

In a possible implementation, after the unmanned aerial vehicle enters the preset landing region, first a plurality of stored Doppler frequency values may be obtained, and when it is determined that each of the Doppler frequency values is greater than or equal to the preset frequency threshold, the first location and the second location are determined according to the Doppler frequency values. Exemplarily, when it is determined that the obtained plurality of Doppler frequency values are all greater than 0, it indicates that the unmanned aerial vehicle flies in a direction close to the signal transmitting apparatus. In this case, the unmanned aerial vehicle may be controlled to continue to fly in the current flight direction. When it is determined that the obtained plurality of Doppler frequency values are all less than 0, it indicates that the unmanned aerial vehicle flies in a direction away from the signal transmitting apparatus. In this case, the unmanned aerial vehicle may be controlled to fly in a direction opposite to the current flight direction. When it is determined that the unmanned aerial vehicle flies in the direction close to the signal transmitting apparatus, the first location and the second location are determined according to the Doppler frequency values.

FIG. 6 is a flowchart of another method for controlling an unmanned aerial vehicle according to an exemplary embodiment of the present disclosure. As shown in FIG. 6, an implementation of S103 may further include:

S1035: Determine a third location in the target flight direction.

A difference between a Doppler frequency value of the third location and the preset frequency threshold is less than or equal to the preset difference threshold.

Exemplarily, in the flight process of the unmanned aerial vehicle in the target flight direction, after each time the Doppler frequency value of the current location is determined, the Doppler frequency value of the current location may be compared with the preset frequency threshold. If the difference between the Doppler frequency value of the current location and the preset frequency threshold is less than or equal to the preset difference threshold, the current location is used as the third location.

S1036: Determine the target location according to the third location and the target flight direction.

S1037: Control the unmanned aerial vehicle to fly in the target flight direction from the third location to the target location.

Exemplarity, in a flight process of the unmanned aerial vehicle in the target flight direction, the signal receiving apparatus of the unmanned aerial vehicle determines the Doppler frequency value according to the received electromagnetic wave signal. With the preset frequency threshold and the preset difference threshold being both 0 as an example, if it is determined that the Doppler frequency value is 0, the location of which the Doppler frequency value is 0 may be used as the third location. After the third location is determined, a second preset distance (also referred to as a second preset flight distance, or a second flight distance) may be obtained, and the unmanned aerial vehicle is controlled to continue to fly in the target flight direction from the third location for the second preset distance, to arrive at the target location. For the manner in which the second preset distance is determined, refer to the manner in which the first preset distance (also referred to as the first preset flight distance, or the first flight distance) is determined, and descriptions thereof are omitted herein. The second preset distance may be the same as the first preset distance, or may be different from the first preset distance, which is not limited in the present disclosure.

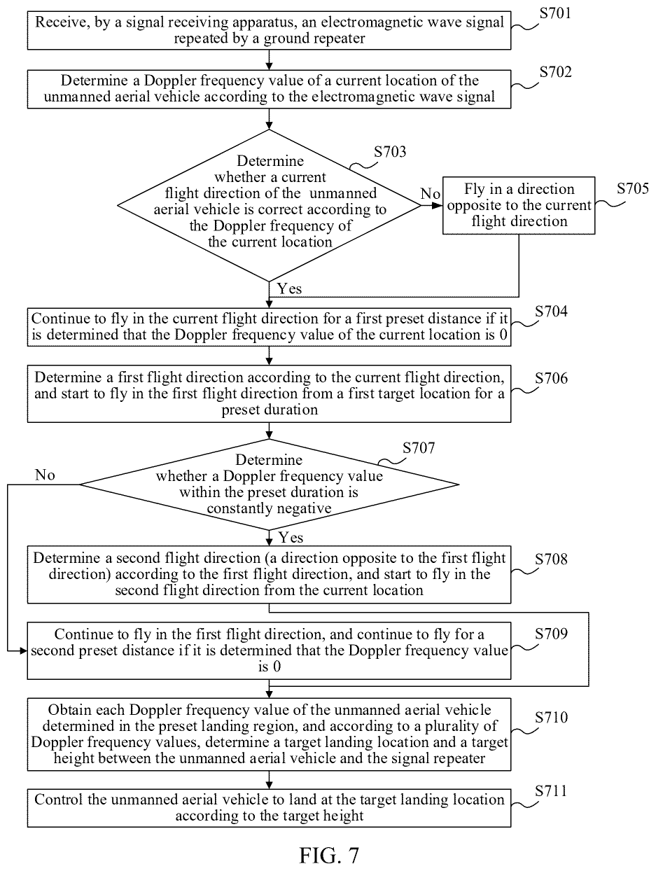

FIG. 7 is a flowchart of another method for controlling an unmanned aerial vehicle according to an exemplary embodiment of the present disclosure. As shown in FIG. 7, the method uses an example where the signal transmitting apparatus is a signal repeater placed at a parking apron on the ground, and the preset frequency threshold is 0. The method is applied to an unmanned aerial vehicle and may include:

S701: Receive, by a signal receiving apparatus, an electromagnetic wave signal repeated by the ground repeater.

S702: Determine a Doppler frequency value of a current location of the unmanned aerial vehicle according to the electromagnetic wave signal.

S703: Determine whether a current flight direction of the unmanned aerial vehicle is correct according to the Doppler frequency of the current location, and if the current flight direction is correct, perform step S704, or if the current flight direction is incorrect, perform step S705.

S704: Continue to fly in the current flight direction for a first preset distance if it is determined that the Doppler frequency value of the current location is 0.

S705: Fly in a direction opposite to the current flight direction, and perform step S704.

S706: Determine a first flight direction according to the current flight direction, and start to fly in the first flight direction from a first target location for a preset duration.

S707: Determine whether a Doppler frequency value within the preset duration is constantly negative, and if the Doppler frequency value is constantly negative, perform step S708, or if the Doppler frequency value is constantly positive, perform step S709.

S708: Determine a second flight direction (a direction opposite to the first flight direction) according to the first flight direction, and start to fly in the second flight direction from the current location.

S709: Continue to fly in the first flight direction, and continue to fly for a second preset distance if it is determined that the Doppler frequency value is 0.

S710: Obtain each Doppler frequency value of the unmanned aerial vehicle determined in the preset landing region, and according to a plurality of Doppler frequency values, determine a target landing location and a target height between the unmanned aerial vehicle and the signal repeater.

S711: Control the unmanned aerial vehicle to land at the target landing location according to the target height.

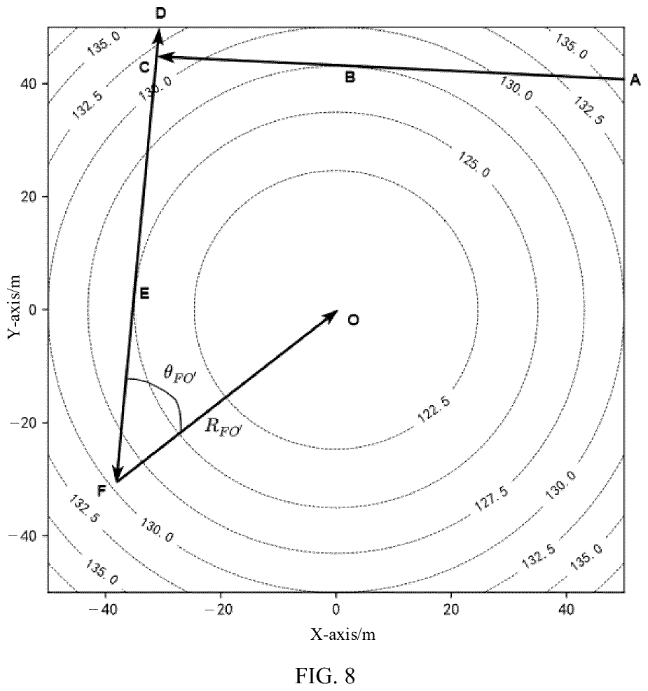

Exemplarily, FIG. 8 is a schematic diagram of a process of guiding an unmanned aerial vehicle to land according to an exemplary embodiment of the present disclosure. As shown in FIG. 8, a rectangular box represents the preset landing region, O is a center (the location of the signal transmitting apparatus) of a parking apron on the ground, and different circles represent different slope distances R. After flying from a point A to the preset landing region in a fixed-height mode at a constant speed, the unmanned aerial vehicle continues to fly at the current height and the constant speed. In the flight process, an electromagnetic wave signal transmitted by the signal transmitting apparatus at the center of the parking apron on the ground is received by a signal receiving module, a Doppler frequency value of the current location of the unmanned aerial vehicle is determined according to the electromagnetic wave signal and the Doppler frequency value is stored. When a plurality of Doppler frequency values determined are all greater than or equal to 0, the unmanned aerial vehicle may be controlled to continue to fly in the current flight direction. When the plurality of Doppler frequency values determined are all less than 0, the unmanned aerial vehicle may be controlled to fly in a direction opposite to the current flight direction. In FIG. 8, after the unmanned aerial vehicle enters the preset landing region from the point A, because the current flight direction is close to the signal transmitting apparatus, the Doppler frequency value in the flight process of the unmanned aerial vehicle is also positive.

After the unmanned aerial vehicle flies to a point B, it is determined that the Doppler frequency value is 0, and the unmanned aerial vehicle is controlled to continue to fly in the current flight direction for a first preset distance, to arrive at a point C. The first flight direction is determined according to the current flight direction of the unmanned aerial vehicle. The first flight direction may be a direction pointing to a point D in FIG. 8. The unmanned aerial vehicle is controlled to fly in the first flight direction from the point B for a preset duration (including the duration spent in flying for the first preset distance). A plurality of first Doppler frequency values determined within the preset duration are obtained. When it is determined that the plurality of first Doppler frequency values are all less than 0, it indicates that the unmanned aerial vehicle flies in a direction away from the signal transmitting apparatus. In this case, the second flight direction (a direction opposite to the first flight direction) may be determined, for example, a direction pointing to a point E in FIG. 8. The unmanned aerial vehicle is controlled to start to fly in the second flight direction from the current location (for example, the location of the unmanned aerial vehicle when the second flight direction is determined). When it is determined that the Doppler frequency value is 0, it may be determined that the unmanned aerial vehicle arrives at the point E.

The unmanned aerial vehicle is controlled to continue to fly from the point E to a point F for the second preset distance. A plurality of Doppler frequency values, from the point A to the point F, stored in the unmanned aerial vehicle are obtained. A location O of which the Doppler frequency value is 0, a relative location relationship (R_{FO′},θ_{F0′}) between the point F where the unmanned aerial vehicle is currently located and the point O, and a target height between the unmanned aerial vehicle and the signal transmitting apparatus are obtained by a two-dimensional curve fitting method according to the plurality of Doppler frequency values. As shown in FIG. 8, R_{FO′} is a distance between the point F and the point O, and θ_{FO′} is an angle between DF and OF. The unmanned aerial vehicle is controlled to fly from the point F to the point O according to the relative location relationship, and the unmanned aerial vehicle is controlled to land at the point O according to the target height.

By the aforementioned method, the unmanned aerial vehicle may achieve autonomous landing only by using the signal transmitting apparatus and the signal receiving apparatus. Costs of the signal transmitting apparatus and the signal receiving apparatus are relatively low, thereby reducing operation costs of the unmanned aerial vehicle. In addition, in a case that the signal receiving apparatus is placed on the unmanned aerial vehicle end and the signal transmitting apparatus is arranged on the ground end, the unmanned aerial vehicle end only receives a signal and does not transmit a signal, thereby avoiding cross-talk among a plurality of unmanned aerial vehicles. Based on this, simultaneous landing of a plurality of unmanned aerial vehicles can be achieved. Because the ground end only transmits a signal and does not receive a signal, impacts of clutter, false alarm, multipath, and the like are avoided. In addition, the unmanned aerial vehicle may achieve autonomous landing according to a received electromagnetic wave signal, without the need for a communication link. In addition, because the transmitting power of the signal transmitting apparatus only has one-way attenuation, the maximum acting distance is longer, and the unmanned aerial vehicle can be better guided to land. Further, because a change in a slope distance in a region right above the signal transmitting apparatus is relatively small, the changing amplitude of the Doppler frequency values is also relatively small. The unmanned aerial vehicle of the present disclosure may obtain a plurality of Doppler frequency values in a flight process in an orthogonal flight direction, and the target landing location determined by two-dimensional fitting is more accurate, thereby improving the accuracy in landing of the unmanned aerial vehicle.

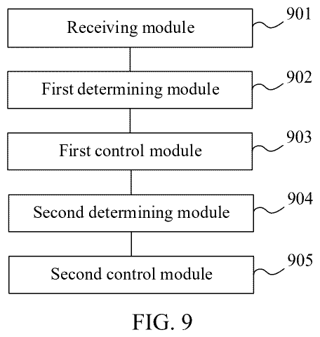

FIG. 9 is a block diagram of an apparatus for controlling an unmanned aerial vehicle according to an exemplary embodiment of the present disclosure. As shown in FIG. 9, the apparatus may include:

a receiving module 901, configured to receive, by a signal receiving apparatus, an electromagnetic wave signal periodically transmitted by a signal transmitting apparatus;

a first determining module 902, configured to determine a Doppler frequency value of a current location of the unmanned aerial vehicle according to the electromagnetic wave signal;
a first control module 903, configured to control the unmanned aerial vehicle to fly in a target flight path to a target location according to the Doppler frequency value of the current location, where the target flight path includes a flight path corresponding to a current flight direction of the unmanned aerial vehicle and a flight path corresponding to a target flight direction that forms an orthogonality relationship with the current flight direction, or in other words, the target flight path includes flight paths respectively corresponding to the current flight direction and the target flight direction of the unmanned aerial vehicle, and the target flight direction forms an orthogonality relationship with the current flight direction;
a second determining module 904, configured to determine a target landing location corresponding to the unmanned aerial vehicle according to a plurality of Doppler frequency values determined in the target flight path of the unmanned aerial vehicle, where a location of the signal transmitting apparatus or the signal receiving apparatus is below the target landing location; and
a second control module 905, configured to control the unmanned aerial vehicle to land at the target landing location.

Optionally, the first control module 903 is configured to: determine a first location and a second location according to the Doppler frequency value of the current location; control the unmanned aerial vehicle to fly in the current flight direction from the first location to the second location; determine the target flight direction according to the current flight direction; and control the unmanned aerial vehicle to fly in the target flight direction from the second location to the target location.

Optionally, the first control module 903 is configured to: use a location at which a difference between the Doppler frequency value of the current location and a preset frequency threshold (also referred to as a frequency threshold) is less than or equal to a preset difference threshold (also referred to as a difference threshold) as the first location, namely, determine the first location, where the difference between the Doppler frequency value of the current location and the frequency threshold is less than or equal to the difference threshold when the current location is the first location; and determine the second location according to the first location, the current flight direction, and a first preset flight distance (also referred to as a first flight distance).

Optionally, the first control module 903 is configured to: determine a first flight direction according to the current flight direction, where the first flight direction is any direction that forms an orthogonality relationship with the current flight direction; control the unmanned aerial vehicle to fly in the first flight direction from the second location for a preset duration (also referred to as a reference duration); and determine the target flight direction according to a plurality of first Doppler frequency values and the first flight direction, where the plurality of first Doppler frequency values are determined in a flight process of the preset duration.

Optionally, the first control module 903 is configured to: use the first flight direction as the target flight direction when determining that the plurality of first Doppler frequency values are all greater than or equal to the preset frequency threshold; or, use a second flight direction as the target flight direction when determining that the plurality of first Doppler frequency values are all less than the preset frequency threshold, where the second flight direction is opposite to the first flight direction.

Optionally, the first control module 903 is configured to: determine a third location in the target flight direction, where a difference between a Doppler frequency value of the third location and the preset frequency threshold is less than or equal to the preset difference threshold; determine the target location according to the third location and the target flight direction; and control the unmanned aerial vehicle to fly in the target flight direction from the third location to the target location.

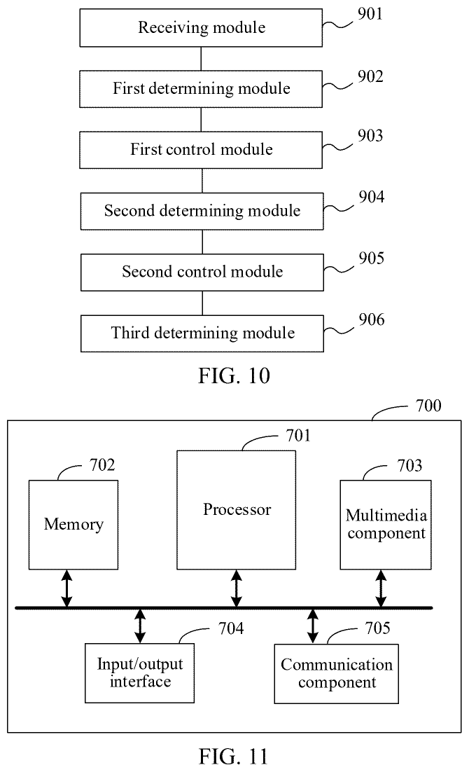

Optionally, FIG. 10 is a block diagram of another apparatus for controlling an unmanned aerial vehicle according to an exemplary embodiment of the present disclosure. As shown in FIG. 10, the apparatus further includes a third determining module 906, configured to determine that the unmanned aerial vehicle flies to a preset landing region (also referred to as a landing region) in a fixed-height mode at a constant speed, where the preset landing region includes the target flight path.

Optionally, the signal receiving apparatus is located at the unmanned aerial vehicle, and the signal transmitting apparatus is located below the target landing location; or, the signal transmitting apparatus is located at the unmanned aerial vehicle, and the signal receiving apparatus is located below the target landing location.

Optionally, the second determining module 904 is configured to determine the target landing location by means of two-dimensional curve fitting based on the plurality of Doppler frequency values and locations corresponding to the plurality of Doppler frequency values.

By using the aforementioned apparatus, the Doppler frequency values of a plurality of locations in the flight process of the unmanned aerial vehicle are determined according to the electromagnetic wave signal transmitted between the unmanned aerial vehicle and the landing point, the target landing location is determined according to the plurality of Doppler frequency values, and the unmanned aerial vehicle is controlled to land at the target landing location, thereby achieving precise landing of the unmanned aerial vehicle. In addition, the unmanned aerial vehicle does not need a communication link to participate during the entire landing process, thereby saving costs of the unmanned aerial vehicle. Further, in a case that the signal transmitting apparatus is a signal repeater, the signal repeater can amplify the electromagnetic wave signal when repeating the electromagnetic wave signal, thereby increasing a control range of the unmanned aerial vehicle.

Specific implementations of operations performed by the modules of the apparatuses in the aforementioned embodiments have been described in detail in the embodiments related to the method, and are not described in detail herein.

FIG. 11 is a block diagram of an electronic device 700 according to an exemplary embodiment of the present disclosure. As shown in FIG. 11, the electronic device 700 may include: a processor 701 and a memory 702. The electronic device 700 may further include one or more of a multimedia component 703, an input/output interface 704, and a communication component 705.

The processor 701 is configured to control overall operations of the electronic device 700, to implement all or some steps in the method for controlling an unmanned aerial vehicle. The memory 702 is configured to store various types of data to support operations on the electronic device 700. The data may include, for example, instructions of any application program or method used for the operations on the electronic device 700, and data related to the application program, for example, contact data, received and sent messages, images, audio, and video. The memory 702 may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The multimedia component 703 may include a screen and an audio component. The screen may be, for example, a touchscreen, and the audio component is configured to output and/or input an audio signal. For example, the audio component may include a microphone, and the microphone is configured to receive an external audio signal. The received audio signal may be further stored in the memory 702 or sent by the communication component 705. The audio component further includes at least one speaker, configured to output an audio signal. The input/output interface 704 provides an interface between the processor 701 and other interface modules. The other interface modules may be a keyboard, a mouse, buttons, and the like. The buttons may be virtual buttons or physical buttons. The communication component 705 is configured to perform wired or wireless communication between the electronic device 700 and other devices. The wireless communication may be, for example, Wi-Fi, Bluetooth, near field communication (NFC), 2G, 3G, 4G, NB-IOT, eMTC, other 5G, or the like, or a combination of one or more of them, which is not limited herein. Therefore, correspondingly the communication component 705 may include a Wi-Fi module, a Bluetooth module, an NFC module, or the like.

In an exemplary embodiment, the electronic device 700 may be implemented by one or more application specific integrated circuits (ASIC), a digital signal processor (DSP), a digital signal processing device (DSPD), a programmable logic device (PLD), a field programmable gate array (FPGA), a controller, a microcontroller, a microprocessor, or other electronic elements, to perform the method for controlling an unmanned aerial vehicle.

In another exemplary embodiment, a non-transitory computer-readable storage medium including a program instruction is further provided. When executed by a processor, the program instruction implements steps of the method for controlling an unmanned aerial vehicle. For example, the non-transitory computer-readable storage medium may be the memory 702 including a program instruction, and the program instruction may be executed by the processor 701 of the electronic device 700 to implement the method for controlling an unmanned aerial vehicle.

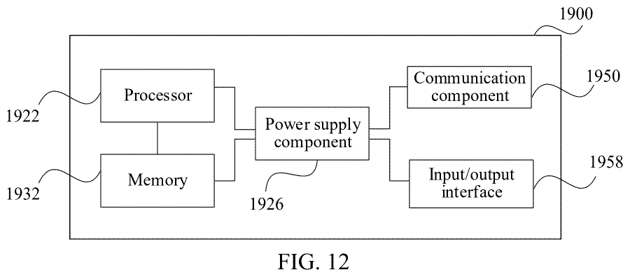

FIG. 12 is a block diagram of another electronic device 1900 according to an exemplary embodiment of the present disclosure. For example, the electronic device 1900 may be provided as a server. Referring to FIG. 12, the electronic device 1900 includes one or more processors 1922, and a memory 1932 configured to store a computer program executable by the processor 1922. The computer program stored in the memory 1932 may include one or more modules, each of which corresponds to one set of instructions. In addition, the processor 1922 may be configured to execute the computer program, to perform the method for controlling an unmanned aerial vehicle.

In addition, the electronic device 1900 may further include a power supply component 1926 and a communication component 1950. The power supply component 1926 may be configured to perform power supply management of the electronic device 1900. The communication component 1950 may be configured to implement communication, for example, wired or wireless communication, of the electronic device 1900. In addition, the electronic device 1900 may further include an input/output (I/O) interface 1958. The electronic device 1900 may operate an operating system stored in the memory 1932.

In another exemplary embodiment, a non-transitory computer-readable storage medium including a program instruction is further provided. When executed by a processor, the program instruction implements steps of the method for controlling an unmanned aerial vehicle. For example, the non-transitory computer-readable storage medium may be the memory 1932 including a program instruction, and the program instruction may be executed by the processor 1922 of the electronic device 1900 to implement the method for controlling an unmanned aerial vehicle.

In another exemplary embodiment, a computer program product is further provided. The computer program product includes a computer program executable by a programmable apparatus, and the computer program includes a code portion configured for performing the method for controlling an unmanned aerial vehicle when executed by the programmable apparatus.

Preferred implementations of the present disclosure are described in detail above with reference to the accompanying drawings. However, the present disclosure is not limited to the specific details in the implementations. Various simple variations may be made to the technical solutions of the present disclosure within the scope of the technical concept of the present disclosure, and these simple variations all fall within the protection scope of the present disclosure. In addition, it should be noted that the specific technical features described in the specific implementations may be combined in any proper manner without contradiction. To avoid unnecessary repetition, possible combinations will not be described in the present disclosure.

In addition, different implementations of the present disclosure may also be arbitrarily combined without departing from the idea of the present disclosure, and the combinations shall still be regarded as contents disclosed in the present disclosure.

1. A method for controlling an unmanned aerial vehicle, comprising:
receiving, by a signal receiving apparatus, an electromagnetic wave signal periodically transmitted by a signal transmitting apparatus;
determining a Doppler frequency value of a current location of the unmanned aerial vehicle according to the electromagnetic wave signal;
controlling the unmanned aerial vehicle to fly in a target flight path to a target location according to the Doppler frequency value of the current location, wherein the target flight path comprises flight paths respectively corresponding to a current flight direction and a target flight direction of the unmanned aerial vehicle, and the target flight direction forms an orthogonality relationship with the current flight direction;
determining a target landing location corresponding to the unmanned aerial vehicle according to a plurality of Doppler frequency values determined in the target flight path of the unmanned aerial vehicle, wherein a location of the signal transmitting apparatus or the signal receiving apparatus is below the target landing location; and
controlling the unmanned aerial vehicle to land at the target landing location.

2. The method according to claim 1, wherein the controlling the unmanned aerial vehicle to fly in a target flight path to a target location according to the Doppler frequency value of the current location comprises:
determining a first location and a second location according to the Doppler frequency value of the current location;
controlling the unmanned aerial vehicle to fly in the current flight direction from the first location to the second location;
determining the target flight direction according to the current flight direction; and
controlling the unmanned aerial vehicle to fly in the target flight direction from the second location to the target location.

3. The method according to claim 2, wherein the determining a first location and a second location according to the Doppler frequency value of the current location comprises:
determining the first location, wherein a difference between the Doppler frequency value of the current location and a frequency threshold is less than or equal to a difference threshold when the current location is the first location; and
determining the second location according to the first location, the current flight direction, and a first flight distance.

4. The method according to claim 2, wherein the determining the target flight direction according to the current flight direction comprises:
determining a first flight direction according to the current flight direction, wherein the first flight direction is any direction that forms an orthogonality relationship with the current flight direction;
controlling the unmanned aerial vehicle to fly in the first flight direction from the second location for a reference duration; and
determining the target flight direction according to a plurality of first Doppler frequency values and the first flight direction, wherein the plurality of first Doppler frequency values are determined in a flight process of the reference duration.

5. The method according to claim 4, wherein the determining the target flight direction according to a plurality of first Doppler frequency values and the first flight direction comprises:
using the first flight direction as the target flight direction when determining that the plurality of first Doppler frequency values are all greater than or equal to the frequency threshold; or,
using a second flight direction as the target flight direction when determining that the plurality of first Doppler frequency values are all less than the frequency threshold, wherein the second flight direction is opposite to the first flight direction.

6. The method according to claim 2, wherein the controlling the unmanned aerial vehicle to fly in the target flight direction from the second location to the target location comprises:
determining a third location in the target flight direction, wherein a difference between a Doppler frequency value of the third location and the frequency threshold is less than or equal to the difference threshold;
determining the target location according to the third location and the target flight direction; and
controlling the unmanned aerial vehicle to fly in the target flight direction from the third location to the target location.

7. The method according to claim 1, wherein before the receiving, by a signal receiving apparatus, an electromagnetic wave signal periodically transmitted by a signal transmitting apparatus, the method further comprises:
determining that the unmanned aerial vehicle flies to a landing region in a fixed-height mode at a constant speed, wherein the landing region comprises the target flight path.

8. The method according to claim 1, wherein the signal receiving apparatus is located at the unmanned aerial vehicle, and the signal transmitting apparatus is located below the target landing location; or, the signal transmitting apparatus is located at the unmanned aerial vehicle, and the signal receiving apparatus is located below the target landing location.

9. The method according to claim 1, wherein the determining a target landing location corresponding to the unmanned aerial vehicle according to a plurality of Doppler frequency values determined in the target flight path of the unmanned aerial vehicle comprises:
determining the target landing location by means of two-dimensional curve fitting based on the plurality of Doppler frequency values and locations corresponding to the plurality of Doppler frequency values.

10-13. (canceled)

14. An electronic device, comprising:
a memory, having a computer program stored thereon; and
a processor, upon executing the computer program in the memory, is configured to: receive an electromagnetic wave signal periodically transmitted by a signal transmitting apparatus;
determine a Doppler frequency value of a current location of an unmanned aerial vehicle according to the electromagnetic wave signal;
control the unmanned aerial vehicle to fly in a target flight path to a target location according to the Doppler frequency value of the current location, wherein the target flight path comprises flight paths respectively corresponding to a current flight direction and a target flight direction of the unmanned aerial vehicle, and the target flight direction forms an orthogonality relationship with the current flight direction;
determine a target landing location corresponding to the unmanned aerial vehicle according to a plurality of Doppler frequency values determined in the target flight path of the unmanned aerial vehicle, wherein a location of the signal transmitting apparatus or the signal receiving apparatus is below the target landing location; and
control the unmanned aerial vehicle to land at the target landing location.

15. The electronic device according to claim 14, wherein the processor is specifically configured to:
determine a first location and a second location according to the Doppler frequency value of the current location;
control the unmanned aerial vehicle to fly in the current flight direction from the first location to the second location;
determine the target flight direction according to the current flight direction; and
control the unmanned aerial vehicle to fly in the target flight direction from the second location to the target location.

16. The electronic device according to claim 15, wherein the processor is specifically configured to:
determine the first location, wherein a difference between the Doppler frequency value of the current location and a frequency threshold is less than or equal to a difference threshold when the current location is the first location; and
determine the second location according to the first location, the current flight direction, and a first flight distance.

17. The electronic device according to claim 15, wherein the processor is specifically configured to:
determine a first flight direction according to the current flight direction, wherein the first flight direction is any direction that forms an orthogonality relationship with the current flight direction;
control the unmanned aerial vehicle to fly in the first flight direction from the second location for a reference duration; and
determine the target flight direction according to a plurality of first Doppler frequency values and the first flight direction, wherein the plurality of first Doppler frequency values are determined in a flight process of the reference duration.

18. The electronic device according to claim 17, wherein the processor is specifically configured to:
use the first flight direction as the target flight direction when determining that the plurality of first Doppler frequency values are all greater than or equal to the frequency threshold; or,
use a second flight direction as the target flight direction when determining that the plurality of first Doppler frequency values are all less than the frequency threshold, wherein the second flight direction is opposite to the first flight direction.

19. The electronic device according to claim 15, wherein the processor is specifically configured to:
determine a third location in the target flight direction, wherein a difference between a Doppler frequency value of the third location and the frequency threshold is less than or equal to the difference threshold;
determine the target location according to the third location and the target flight direction; and
control the unmanned aerial vehicle to fly in the target flight direction from the third location to the target location.

20. The electronic device according to claim 14, wherein the processor is further configured to:
determine that the unmanned aerial vehicle flies to a landing region in a fixed-height mode at a constant speed, wherein the landing region comprises the target flight path.

21. The electronic device according to claim 14, wherein the signal receiving apparatus is located at the unmanned aerial vehicle, and the signal transmitting apparatus is located below the target landing location; or, the signal transmitting apparatus is located at the unmanned aerial vehicle, and the signal receiving apparatus is located below the target landing location.

22. The electronic device according to claim 14, wherein the processor is specifically configured to:
determine the target landing location by means of two-dimensional curve fitting based on the plurality of Doppler frequency values and locations corresponding to the plurality of Doppler frequency values.

23. A non-transitory computer-readable storage medium, having a computer program stored thereon, wherein the computer program, upon being executed by a processor, is used for implementing a method for controlling an unmanned aerial vehicle, and the method comprises:
receiving an electromagnetic wave signal periodically transmitted by a signal transmitting apparatus;
determining a Doppler frequency value of a current location of the unmanned aerial vehicle according to the electromagnetic wave signal;
controlling the unmanned aerial vehicle to fly in a target flight path to a target location according to the Doppler frequency value of the current location, wherein the target flight path comprises flight paths respectively corresponding to a current flight direction and a target flight direction of the unmanned aerial vehicle, and the target flight direction forms an orthogonality relationship with the current flight direction;
determining a target landing location corresponding to the unmanned aerial vehicle according to a plurality of Doppler frequency values determined in the target flight path of the unmanned aerial vehicle, wherein a location of the signal transmitting apparatus or the signal receiving apparatus is below the target landing location; and
controlling the unmanned aerial vehicle to land at the target landing location.
